(19) United States
(12) Patent Application Publication
(10) Pub. No.: US 2011/0167601 A1
(43) Pub. Date: Jul. 14, 2011

(54) RESTORATION/EMBALMING KIT

(75) Inventors: John R. Jaskulske, Maplewood, MN (US); Peter J. Helgeson, Roseau, MN (US); Ty B. Sunderman, Elk River, MN (US)

(73) Assignee: Innovative Supply, Inc., St. Paul, MN (US)

(21) Appl. No.: 12/603,962

(22) Filed: Oct. 22, 2009

Related U.S. Application Data
(60) Provisional application No. 61/107,488, filed on Oct. 22, 2008.

(51) Int. Cl. A01N 1/00

(52) U.S. Cl. 27/22.1; 27/21.1

(57) ABSTRACT

A two-part system for the restoration and preservation of a deceased's limbs where the deceased was a donor of one or more long bones includes a procurement kit and an embalmer's kit. The procurement kit includes at least one absorbent pad, an artificial artery and a clamp for sealing an end of the artery. The procurement team secures the artificial artery from the kit in the deceased's affected limb such that an open end of the artery is accessible to the embalmer eliminating the need for the embalmer to re-open the limb during the embalming procedure. The embalmer's kit includes materials for completing the preservation of the limb, including an absorbent stockinette, an absorbent garment such as a stocking or a sleeve, and a fluid-impermeable plastic garment.

### CROSS-REFERENCE TO RELATED APPLICATION

This application claims the benefit under 35 U.S.C. §119 of U.S. Provisional Application No. 61/107,488, filed on Oct. 22, 2008, entitled “Restoration/Embalming Kit,” which is incorporated herein by reference in its entirety for all purposes.

### TECHNICAL FIELD

The present invention relates to a restoration/embalming system for the preservation of a deceased's body. More particularly, the present invention relates to a restoration/embalming system for the restoration and preservation of a deceased's body where the deceased was a donor of one or more long bones.

### BACKGROUND

Embalming, in most modern cultures, is the art and science of temporarily preserving human remains to forestall decomposition and to make them suitable for display at a funeral. The three goals of embalming are sanitization, presentation, and preservation (or restoration) of the deceased's body to achieve this effect.

### SUMMARY

According to various embodiments, the present invention is a restoration/embalming system adapted to be used in situations where a deceased human being was a donor of the long bones of either the legs and/or arms. The system includes all necessary items needed to preserve, through the embalming process, the remaining tissues following such procurements.

According to one embodiment, the present invention is a kit for the embalming and restoration of a deceased's body including at least one absorbent pad adapted to absorb and retain large amounts of fluid and at least one artificial artery. A prosthetic can optionally be included in the kit. The artificial artery includes a semi-flexible, tubular body including a first end, a second end, a lumen extending between the first and second ends, and a plurality of apertures in fluid communication with the lumen and spaced along a length and of the tubular body to facilitate the even distribution of fluid during an embalming procedure. Additionally, the kit can include one or more hose clamps for sealing an open end of the artificial artery and one or more zip ties or other suitable fasteners for securing the artificial artery to a prosthetic. According to some embodiments, the kit further includes an absorbent stockinette, an absorbent garment including an inner absorbent layer and an outer fluid impermeable layer, and a fluid-impermeable garment.

According to another embodiment, the present invention is an artificial artery to be used in a restoration and embalming procedure where the deceased was a donor of one or more long bones.

According to yet another embodiment, the present invention is a method of restoring and embalming a deceased's limb.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1A is a schematic view of a procurement kit in accordance with an embodiment of the present invention.

FIG. 1B is a schematic view of an embalmer's kit in accordance with an embodiment of the present invention.

FIG. 2 is a schematic drawing of a deceased's legs where the femur, tibia and fibula have been removed and showing the procurement kit in use in accordance with an embodiment of the present invention.

FIGS. 3 and 4 are schematic views of the deceased's legs shown in FIG. 1 during preservation by the embalmer using the embalmer's kit in accordance with an embodiment of the present invention.

### DETAILED DESCRIPTION

The restoration/embalming system as described herein according to various embodiments of the present invention is designed to be used in situations where a deceased human being was a donor of the long bones of either the legs and/or arms. The long bones include the femurs, tibias and fibulas of the legs, and the humerus, radii and ulnas of the arms. The kit includes all of the necessary items needed to preserve, through the embalming process, the remaining tissues following such procurements.

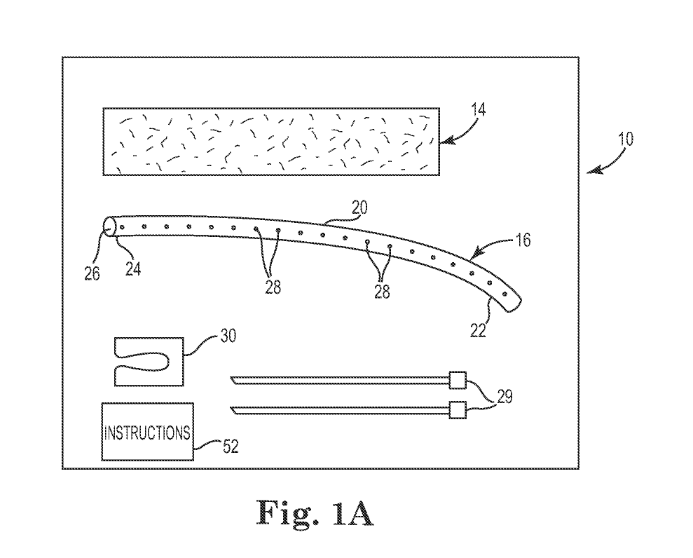

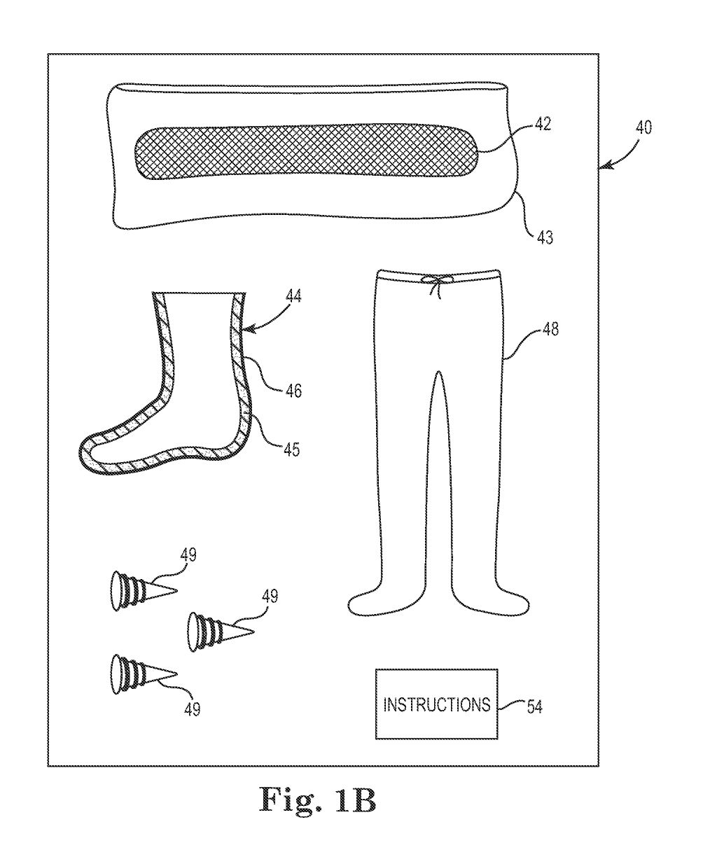

According to various embodiments, the restoration/embalming system is a multi-part system for the restoration and embalming of a deceased's body where the deceased was a donor of one or more long bones. According to one embodiment, the multi-part system includes a first kit (FIG. 1A) including materials to be used by the procurement team (“the procurement kit”) and a second kit (FIG. 1B) including materials to be used by the embalmer to ensure proper preservation of the remaining tissues (“the embalmer's kit”). In some applications, the procurement kit and the embalmer's kit can be provided separately as individual kits. Additionally, different numbers of procurement kits and embalmer's kits may be combined to form a system to complete the restoration and embalming of the deceased's body.

According to one embodiment, as shown in FIG. 1A, the procurement kit 10 includes at least one absorbent pad 14 and at least one artificial artery 16 package together in an enclosure. The procurement kit 10 can also include additional items to facilitate installation of the kit 10, particularly the artificial artery 16, including one or more zip ties 29 or other similar fastening devices, one or more hose clamps 30, and instructions 52.

The absorbent pad 14 included in the procurement kit 10 is adapted to wick and retain relatively large amounts of fluid. The absorbent pad 14 is made from a highly absorbent material similar to that used in diapers. Suitable absorbent pads and materials are available through various mortuary suppliers.

The overall size of the absorbent pad 14 can vary. For example, the absorbent pad 14 can range from about 2 to about 24 inches wide and from about 1 to about 8 feet long. The thickness of the absorbent pad 14 can also vary. The absorbent pad 14 can be cut or torn to fit the affected area of the deceased's body. Additionally, the absorbent pad 14 can be rolled up or folded as necessary or desired to fit the affected area. At least one pad 14 will typically be used for every area affected by the procurement of the long bones.

Additionally, as described above, the procurement kit 10 includes at least one artificial artery 16. The artificial artery 16 is installed by a procurement team according to instructions provided to the procurement team for the installation procedure following procurement of the long bones (e.g., instructions 52 enclosed with the kit 10). Typically, at least one artificial artery 16 is needed for each affected area.

The artificial artery 16 is adapted to be connected to a machine designed to distribute fluid and facilitates the even distribution of fluids during the embalming procedure. The artificial artery 16 can be made out of any number of materials including, but not limited to rubber, plastic, plastic polymers, PVC, metal or any other material that is capable of carrying embalming fluid through a part of a deceased person. In one embodiment, the artificial artery 16 is at least semi-flexible. In another embodiment, the artificial artery 16 is flexible.

The artificial artery 16, as shown in FIG. 1A, includes a tubular body 20 having a first end 22 and a second end 24. A lumen 26 extends between the first and second ends 22, 24. In one embodiment, both the first and second ends 22, 24 of the artificial artery 16 are open and can be sealed with a hose clamp such as hose claim 30 included with the kit 30. For example, during installation of the procurement kit 10, the first end 22 is then sealed with a hose clamp 30 or other suitable device to facilitate pressure build-up within the artificial artery 16 during the embalming procedure. In another embodiment, as shown in FIG. 1A, the first end 22 of the artificial artery 16 is sealed while the second end 24 remains open. The artificial artery 16 is installed by the procurement team such that the open end (e.g., second end 24) is accessible to the embalmer.

The artificial artery 16 also includes a plurality of apertures 28 in fluid communication with the lumen. The apertures 28 are adapted to facilitate embalming fluid to spray, seep or weep out of the artificial artery 16 during the embalming procedure. The fluid is contained by the absorbent pad 14, described above. The apertures 28 can vary in number, shape and size. For example, in some embodiments, the apertures 28 can be slits or holes formed in the tubular body. In one embodiment, the apertures are spaced along a length and/or about an outer circumference of the tubular body 20 to facilitate the even distribution of fluid during an embalming procedure.

The artificial artery 16 can be of any size in diameter, thickness and length suitable for its function. In one embodiment, a total length of the artificial artery 16 is such that it is equal to or greater than a length of the incision made to remove the long bones during the procurement procedure. Additionally, in some embodiments, the artificial artery 16 can be length-adjustable. For example, the artificial artery 16 can be cut to the length needed to fit the deceased individual.

As described above, the procurement kit 10 also can include additional items to facilitate installation of the kit by the procurement team. This includes zip ties 29 or other suitable fasteners and hose clamps 30. In one embodiment, the procurement kit 10 includes multiple zip ties 29 or fasteners. The zip ties 29 can be range from 2 to 14 inches in length. The ties 29 can be used to secure the artificial artery 16 to the prosthetic, which may be optionally included with the system. Additionally, the kit 10 can optionally include one or more hose clamps 30 adapted to seal an open end of the artificial artery 16 once the artery 16 has been installed in the deceased. The hose clamps 30 can be made of metal or plastic.

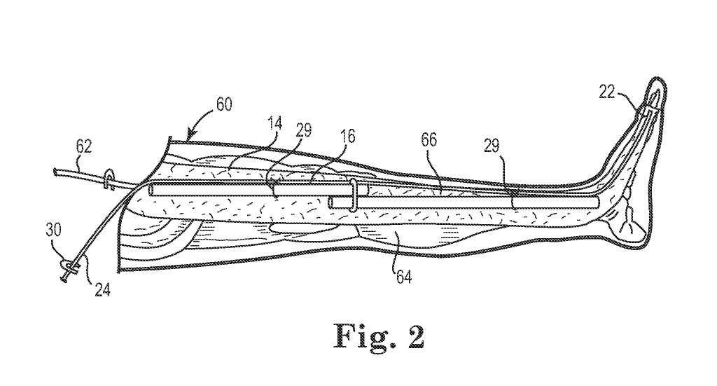

After the artificial artery 16 has been installed by the procurement team, the procurement team then closes the incision made when the long bones were removed from the deceased's limbs. The incision is closed such that the open end 24 of the artificial artery 16 is accessible to the embalmer from outside of the deceased's body as shown in FIG. 2. A hose clamp 30 can be used to seal the open end of the artificial artery 16 until embalming fluid is ready to be introduced into the deceased's body. The deceased is now ready for preservation by the embalmer using the embalmer's kit 40.

The embalmer's kit 40 is shown in FIG. 1B and includes at least one stockinette 42, an absorbent garment 44, and one fluid-impermeable, plastic garment 48 packaged together in an enclosure.

The stockinette 42 is used as in external embalming procedure to facilitate proper preservation of the skin and outer tissues of the leg or arm. The stockinette 42 is made from an absorbent material such as, for example, cotton gauze and can vary in size. For example, the stockinette 42 may be anywhere from 1 to 8 feet in length and from 1 to 24 inches in diameter. In one embodiment, the stockinette 42 can be provided in a Ziploc® bag 43. Embalming fluid is added to the bag 43 during the embalming procedure until the stockinette 42 is saturated. The stockinette 42 is then placed on the affected limb(s) to preserve the outer tissues, including the skin.

The absorbent garment 44 is a stocking or sleeve that is adapted to be fitted over the deceased's affected limb(s) immediately following the placement of the stockinette 42. In one embodiment of the kit 40, the absorbent garment 44 is a stocking 44 adapted to be fitted over the deceased's leg as shown in FIG. 1B. In other embodiments, the kit 40 includes an absorbent sleeve. The absorbent garment 44 is provided to absorb and retain any excess fluids that may leak from or permeate through the stockinette 42. The illustrated embodiment of the absorbent garment 44 includes an inner absorbent layer 45 made of a highly absorbent material and an outer moisture-impermeable layer 46.

The embalmer's kit 40, as shown in FIG. 1B, also includes at least one fluid-impermeable plastic garment 48. The fluid-impermeable, plastic garment 48 is a tertiary method of preventing fluid leakage and containing odor. In one embodiment, as shown in FIG. 1B, the fluid-impermeable, plastic garment 48 is a pair of plastic pants. The garment 48 is adapted to encase the entire lower extremities of the deceased up to the waste line. In other embodiments, the garment 48 can be a sleeve, a full body suit, or the like. The garment 48 can vary in size and can be selected based on the overall size of the deceased.

Additionally, as shown in FIG. 1B, the embalmer's kit 40 can include one or more trocar buttons 49 adapted to seal hypodermic injection holes made by the embalmer during the embalming process. Trocar buttons 49 are adapted to seal and close any small hole, or perforation in the skin. An exemplary trocar button suitable for use in this kit is the Multi-Closure™ trocar button, which can be obtained from Innovative Supply Inc. of St. Paul, Minn. According to one embodiment, at least six trocar buttons 49 are included for each area affected.

The restoration/embalming system according to the various embodiments also includes a first set of instructions 52 included with the procurement kit 10 and a second set of instructions 54 included with the embalmer's kit 40. The instructions 52 provided with the procurement kit 10 can provide a step-by-step guide for the procurement team on installing the procurement kit 10 and preparing the affected area of the deceased's body for embalming after one or more long bones has been removed. The instructions 54 provided with the embalmer's kit 40 can provide a step-by step guide for the embalmer for restoring and embalming the affected area of the deceased's body. A copy of the instructions 52 provided with the procurement kit 10 can also be included in the embalmer's kit 40 so the embalmer understands what has been done by the procurement team.

Referring to FIGS. 2-4, a method of restoring and embalming a deceased's leg(s) 60 using the restoration/embalming system as described above will now be described. It is generally understood that a similar method may be employed for the restoration and preservation of a deceased's arms where the deceased has been a long bone donor of the arms.

As shown in FIG. 2, the femoral artery 62 is tied off or otherwise clamped shut. A light layer of absorbent powder (not shown) can, but need not be, applied to the surface of the exposed tissues of each leg 60. Additional powder can be applied in the calf and foot region of the leg 60. The absorbent pad 14 provided in the procurement kit 10 is then laid over the exposed tissues. The absorbent pad 14 can be cut, torn or otherwise sized such that it is approximately equal to the length of the incision 64 made in the leg during the removal of the long bones. A prosthetic 66 is placed on top of the absorbent pad 14. The prosthetic 66 may be optionally contained within the kit 10. The length of the prosthetic 66 can be adjusted as necessary to fit the deceased. The artificial artery 16 is placed alongside the prosthetic 66. The length of the artificial artery 16 also can be adjusted as necessary to fit the deceased. The first end 22 of the artery, if not sealed, is clamped shut using one of the hose clamps 30, provided in the procurement kit 10. The sealed end of the artery 16 facilitates pressure build-up for the distribution of fluids during the embalming procedure. The artificial artery 16 is installed in the leg such that the second or open end 24 of the artificial artery 16 protrudes from the leg and is accessible to the embalmer when the incision is closed. The open end 24 of the artery 16 can be sealed using one of the hose clamps 30 provided in the procurement kit 10 until the embalming procedure commences. The artificial artery 16 can be secured to the prosthetic 66 using one or more zip ties 29 provided with the kit.

After the artificial artery 16 has been secured within the leg 60, the incision 64 is ready to be closed. The absorbent pad 14 is wrapped around the prosthetic 66 and the artificial artery 16 such that the artery 16 is covered by the absorbent pad 14. The incision 64 is then closed as shown in FIG. 2, such that a length of the artificial artery 16 including the open end 24 protrudes from the incision 64 and is accessible to the embalmer. This process is repeated using additional kits as necessary for each affected area. The procurement kit instructions 52 can be provided along with the deceased so that the embalmer understands what steps have been taken by the procurement team in restoring the leg 60.

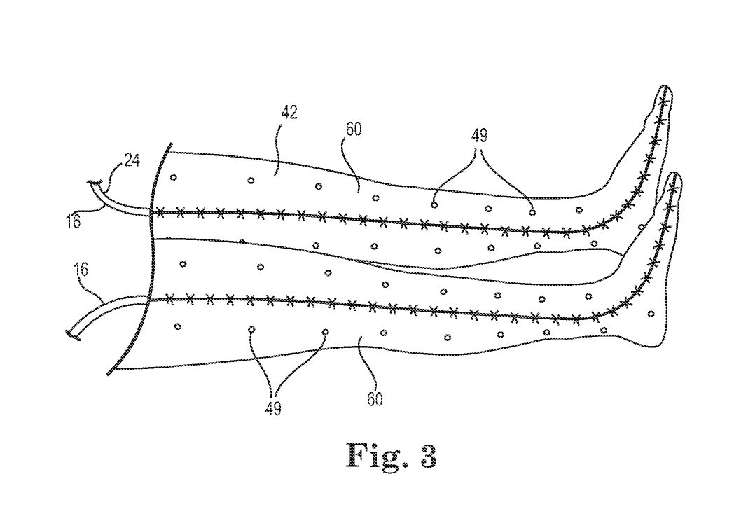

The embalming procedure can then begin using the embalmer's kit 40. An embalming machine is connected to the open end 24 of the artificial artery protruding from the deceased's legs 60 shown in FIG. 3. Embalming fluid is then delivered to the leg 60 through the artificial artery 16 previously installed by the procurement team. Once this step is complete, additional embalming fluid can, if appropriate and needed, be injected into the leg tissues using a hypodermic trocar or other similar instrument. The trocar buttons 49 provided in the embalmer's kit can be used to close the incisions created by the hypodermic trocar. These steps can be repeated using additional kits as necessary for each affected area.

The remaining steps in the embalming procedure are typically completed on the following day or when appropriate.

The stockinette 42 is removed from the kit 40 and placed in the Ziploc® bag 43 provided in the kit. In some embodiments, the stockinette 42 may already be contained in the Ziploc® bag 43. Embalming fluid is added to the bag 43 and the stockinette 42 absorbs the embalming fluid. The stockinette 42 can be squeezed within to facilitate absorption of the fluid. The stockinette 42 is ready to be placed on the leg 60 when the stockinette is saturated with the embalming fluid.

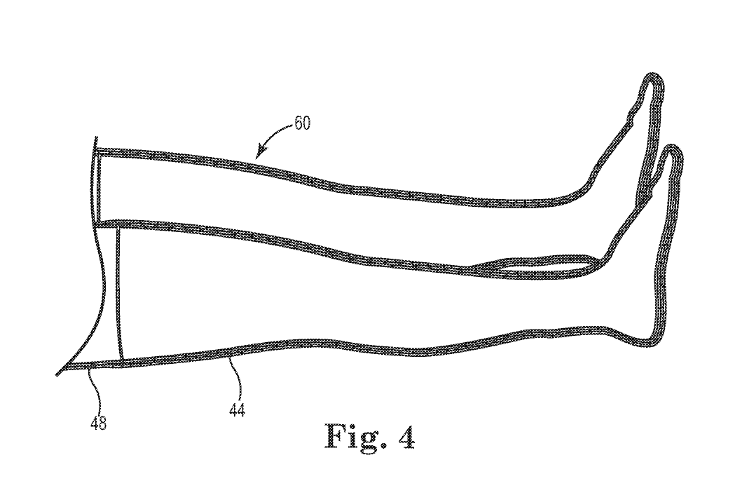

Next, the stockinette 42 is placed over each of the deceased's affected legs 60 such that the leg including the foot is covered by the stockinette 42 as shown in FIG. 3. Each leg 60 including the stockinette 42 is then covered by an absorbent garment 44 such as a stocking as shown in FIG. 4. The fluid-impermeable, plastic garment 48 such as the pants provided in the embalmer's kit 40 are then placed over the deceased's legs up to the deceased's waist line, as is also shown in FIG. 4. The restoration is then complete.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

1. (canceled)

2. (canceled)

3. (canceled)

4. (canceled)

5. (canceled)

6. (canceled)

7. (canceled)

8. (canceled)

9. An artificial artery adapted to distribute embalming fluid within a deceased's body during embalming, the artery comprising:
a semi-flexible, tubular body including a first end, a second end, a lumen extending between the first end and the second end and a plurality of apertures in fluid communication with the lumen and spaced along a length of the tubular body to facilitate the even distribution of fluid during an embalming procedure.

10. (canceled)

11. (canceled)

12. (canceled)

13. (canceled)

14. (canceled)

15. (canceled)

16. (canceled)

17. An artificial artery including an elongated member configured for insertion in and along a length of a deceased's limb during restoration following removal of a long bone from the limb, a lumen extending through the elongated member, an embalming fluid receiving opening in fluid communication with the lumen configured for connection to a source of embalming fluid, and a plurality of embalming fluid distribution openings along a length of the elongated member and in fluid communication with the lumen, for distributing embalming fluid received at the fluid receiving opening throughout the length of the limb into which the artery is inserted.

18. The artificial artery of claim 17 wherein the embalming fluid receiving opening is at a first end of the elongated member.

19. The artificial artery of claim 17 and further including a second opening at an end of the elongated member.

20. A kit including the artificial artery of claim 19, a clamp for closing the second opening of the elongated member, and packaging for containing the artificial artery and clamp.

21. The kit of claim 20 and further including and absorbent pad configured for insertion in and along a length of a deceased's limb with the elongated artery, wherein the absorbent pad is contained in the packaging with the artificial artery and clamp.

22. The kit of claim 21 and further including a prosthetic configured for insertion in and along a length of a deceased's limb with the elongated artery and absorbent pad, wherein the prosthetic is contained in the packaging with the artificial artery, clamp and absorbent pad.

23. The kit of claim 22 and further including one or more ties configured to secure the artificial artery to the prosthetic, wherein the one or more ties are contained in the packaging with the artificial artery, clamp, absorbent pad and prosthetic.

24. A method for use in connection with the restoration of a deceased's limb following removal of a long bone from the limb, including inserting an artificial artery into and along a length of the limb following the removal of the long bone from the limb, the artificial artery including an elongated member, a lumen extending through the elongated member, an embalming fluid receiving opening in fluid communication with the lumen configured for connection to a source of embalming fluid, and a plurality of embalming fluid distribution openings along a length of the elongated member and in fluid communication with the lumen, for distributing embalming fluid received at the fluid receiving opening throughout the length of the limb into which the artery is inserted.

25. The method of claim 24 and further including closing the limb and causing the embalming fluid receiving opening of the artificial artery to extend outside the limb.

26. The method of claim 25 wherein the artificial artery includes a second opening at an end of the elongated member, and wherein the method further includes clamping the second opening.

27. The method of claim 26 and further including opening packaging of a kit containing the artificial artery and a clamp used during the restoration.

28. The method of claim 25 and further including inserting an absorbent pad into and along the length of the limb with the artificial artery.

29. The method of claim 28 and further including opening packaging of a kit containing the artificial artery and the absorbent pad used during the restoration.

30. The method of claim 29 wherein the artificial artery includes a second opening at an end of the elongated member, and wherein the method further includes clamping the second opening with a clamp, and opening packaging of a kit containing the artificial artery, absorbent pad and a clamp used during the restoration.

31. The method of claim 24 and further including inserting a prosthetic into and along the length of the limb with the artificial artery.

32. The method of claim 31 and further including opening packaging of a kit containing the artificial artery and the prosthetic used during the restoration.

33. The method of claim 32 wherein the artificial artery includes a second opening at an end of the elongated member, and wherein the method further includes clamping the second opening with a clamp, inserting an absorbent pad into and along the length of the limb with the artificial artery and opening packaging of a kit containing the artificial artery, absorbent pad, prosthetic and a clamp used during the restoration.

34. The method of claim 33 and further including tying the artificial artery to the prosthetic with one or more ties, and wherein the method further includes opening packaging of a kit containing the artificial artery, absorbent pad, prosthetic, clamp and one or more ties used during the restoration.

35. The method of claim 32 and further including tying the artificial artery to the prosthetic with one or more ties, and wherein the method further includes opening packaging of a kit containing the artificial artery, prosthetic and one or more ties used during the restoration.
